(19) United States
(12) Patent Application Publication
(10) Pub. No.: US 2004/0099117 A1
(43) Pub. Date: May 27, 2004

(54) Woodcutting angle guide for powered hand tools

(76) Inventor: Roy T. Johnson, Deltona, FL (US)

Correspondence Address: EDWARD M. LIVINGSTON, PA, 963 TRAIL TERRACE DRIVE, NAPLES, FL, 34103, US

(21) Appl. No.: 10/307,150

(22) Filed: Nov. 26, 2002

(51) Int. Cl. B26D 5/08

(52) U.S. Cl. 83/581

(57) ABSTRACT

A woodcutting-angle guide for powered hand tools has a tool-guide beam (1) hinged to a feedstock-guide beam (2) that is adjustment-angled from the tool-guide beam with an angle-adjustment rod (3). The angle-adjustment rod has a hinged end (23) that is hinged to the tool-guide beam. For affixing an adjustment angle of the feedstock-guide beam from the tool-guide beam, the angle-adjustment rod includes an angle-adjustment slot (24) in which an angle-adjustment setscrew (17) on the feedstock-guide beam slides fixedly. An angle of the tool-guide beam from the feedstock-guide beam is variable by distance of affixment of the angle-adjustment setscrew from the tool-guide beam in the angle-adjustment slot. This allows a reference edge (22) of a feedstock board (16) to be positioned against a feedstock-guide wall (21) of the feedstock-guide beam and a cut-targeted line (15) of the feedstock board to cross under the tool-guide beam for being cut by a powered hand tool (9-14). A reference edge of the powered hand tool on a tool support surface (8) of the tool-guide beam is positioned in sliding contact with a tool-guide wall (18). The powered hand tool is then hand-pushed across the cut-targeted portion of the feedstock board at an adjustment angle from an axis of the feedstock board. The adjustment angle is determined by distance-positioning of the angle-adjustment setscrew in the angle-adjustment slot in the angle-adjustment rod.

### BACKGROUND OF THE INVENTION

This invention relates to cutting ends and edges of wood at angles with powered hand tools for fitting, mitering, grooving and other preparation of boards for woodworking.

Cutting ends and edges of wood at angles with powered hand tools for fitting, mitering, grooving and other preparation of boards is accomplished generally with table or bench machinery using table-groove guides and pushers for precision wood construction. For using powered hand tools, boards are marked with a protractive instrument to hand-guide the powered hand tools as marked, but with less precision and less repetitive reliability than with the table or bench machinery.

There is no known precision-guide instrument for hand-powered tools to be used with the level of precision and repeatable reliability of table or bench machinery to cut ends and edges of boards or pieces of wood at angles for fitting, mitering, grooving and other preparation of wood for construction components in a manner taught by this invention.

Examples of most-closely related known but different devices are described in the following patent documents:

| U.S. Pat. No. | Inventor | Issue Date |
|---|---|---|
| 5,771,767 | Itami | Jun. 30, 1998 |
| 3,738,211 | Carter, Sr. | Jun. 12, 1973 |
| 5,016,508 | Hallenbeck | May 21, 1991 |
| 5,979,283 | Osborne | Nov. 9, 1999 |
| 4,002,329 | Petrowski | Jan. 11, 1977 |
| 2,968,325 | Wandvik | Jan. 17, 1961 |
| 2,032,976 | Carter | Mar. 3, 1936 |
| 2,672,897 | Cue | Mar. 23, 1954 |

### SUMMARY OF THE INVENTION

Objects of patentable novelty and utility taught by this invention are to provide a woodcutting-angle guide for powered hand tools which:

allows an edge of a board to be utilized as a reference edge for accurately angled and guided woodcutting by a handsaw, router, sander, grinder or other powered hand tool;

provides for the accuracy and repetitive reliability of bench woodworking machinery to be achieved with powered hand tools;

eliminates need and cost for bench machinery for a large portion of woodworking;

can be made for both left-handed and right-handed users; and

is very light, inexpensive, long-lasting and easily stored.

This invention accomplishes these and other objectives with a woodcutting-angle guide for powered hand tools having a tool-guide beam hinged to a feedstock-guide beam that is adjustment-angled from the tool-guide beam with an angle-adjustment rod. The angle-adjustment rod has a tool-guide end that is hinged to the tool-guide beam. For affixing an angle of the feedstock-guide beam from the tool-guide beam, the angle-adjustment rod includes an angle-adjustment slot in which an angle-adjustment setscrew on the feedstock-guide beam slides fixedly. An angle of the tool-guide beam from the feedstock-guide beam is variable triangularly to distance of fixation of the angle-adjustment setscrew from the tool-guide beam in the angle-adjustment slot. This allows a reference edge of a feedstock board to be positioned against a feedstock-guide wall of the feedstock-guide beam and a cut-targeted portion of the feedstock board to cross under the tool-guide beam for being cut by a powered hand tool. A reference edge of the powered hand tool on a top surface of the tool-guide beam is positioned in sliding contact with a tool-guide wall. The powered hand tool is then hand-pushed across the cut-targeted portion of the feedstock board at an adjustment angle from an axis of the feedstock board. The adjustment angle is determined distance-positioning of the angle-adjustment setscrew in the angle-adjustment slot in the angle-adjustment rod.

With distance-positioning of the angle-adjustment setscrew in the angle-adjustment slot for the tool-guide beam to be ninety degrees from the feedstock-guide beam, the adjustment angle is ninety degrees and the targeted cut is orthogonal to the reference edge of the feedstock board. With the tool-guide beam sixty degrees from the feedstock-guide beam, the targeted cut is reciprocally thirty degrees from the reference edge of the feedstock board. With the tool-guide beam forty-five degrees from the feedstock-guide beam, the targeted cut is reciprocally forty-five degrees from the reference edge of the feedstock board. Angle indicia, marks and snap-notches to facilitate affixing the angle-adjustment setscrew for desired adjustment angles can be positioned along the angle-adjustment rod and the angle-adjustment slot selectively.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a top view of a right-handed-user embodiment that is set for cutting a feedstock board in a feedstock-guide beam with a powered hand saw on a tool-guide beam that is angled ninety degrees from the feedstock-guide beam with an angle-adjustment rod;

FIG. 2 is a top view of the right-handed-user embodiment that is set for cutting the feedstock board in the feedstock-guide beam with the powered hand saw on the tool-guide beam that is angled forty-five degrees from the feedstock-guide beam with the angle-adjustment rod;

FIG. 3 is a top view of a left-handed-user embodiment that is set for cutting the feedstock board in the feedstock-guide beam with the powered hand saw on the tool-guide beam that is angled ninety degrees from the feedstock-guide beam with the angle-adjustment rod;

FIG. 4 is a partially cutaway tool-side view of the right-handed-user embodiment that is set for cutting the feedstock board in the feedstock-guide beam with the powered hand saw on the tool-guide beam that is angled ninety degrees from the feedstock-guide beam;

FIG. 5 is a partially cutaway tool-guide-side view of the right-handed-user embodiment that is set for cutting the feedstock board in the feedstock-guide beam with the powered hand saw on the tool-guide beam that is angled ninety degrees from the feedstock-guide beam;

FIG. 6 is a partially cutaway tool-guide-feedstock-end view of the right-handed-user embodiment showing an outside surface of a wall of an upright portion of the angle-adjustment rod having angle indicia and showing an outside surface of a feedstock-guide wall to which an angle-adjustment setscrew is attached pivotally;

FIG. 7 is a partially cutaway tool-guide-distal-end view of the right-handed-user embodiment having a right-angled side of the angle-adjustment rod having an angle-adjustment slot shown with a sidewall removed in a horizontal portion and showing a right-angled side of the feedstock-guide beam having a horizontal portion that rests on a feedstock board and with a feedstock-guide wall extended vertically downward; and

FIG. 8 is the FIG. 6 embodiment having a feedstock board positioned in the feedstock-guide beam in cutting relationship to a selection of powered hand tools represented in dashed lines by heads for the powered hand tool on the tool-guide beam which has stiffeners on a bottom side.

### DESCRIPTION OF PREFERRED EMBODIMENT

Listed numerically below with reference to the drawings are terms used to describe features of this invention. These terms and numbers assigned to them designate the same features throughout this description.

1. Tool-guide beam

2. Feedstock-guide beam

3. Angle-adjustment rod

4. Feedstock end

5. Distal end

6. Tool-guide side

7. Tool side

8. Tool-support surface

9. Powered hand tool

10. Motorized unit

11. Circular saw

12. Milling side cutter

13. Blade saw

14. Router

15. Targeted line

16. Feedstock board

17. Angle-adjustment setscrew

18. Tool-guide wall

19. Tool-guide end

20. Guide support

21. Feedstock-guide wall

22. Reference edge

23. Hinged end

24. Angle-adjustment slot

25. Groove portion

26. Rod distal end

27. Rod vertical wall

28. Setscrew housing

29. Feed end

30. Mating screw thread

31. Finger-rotatable head

32. Setscrew-stop member

33. Inside walls

34. Surface-protective washers

35. Linear stiffeners

36. Hinged attachments

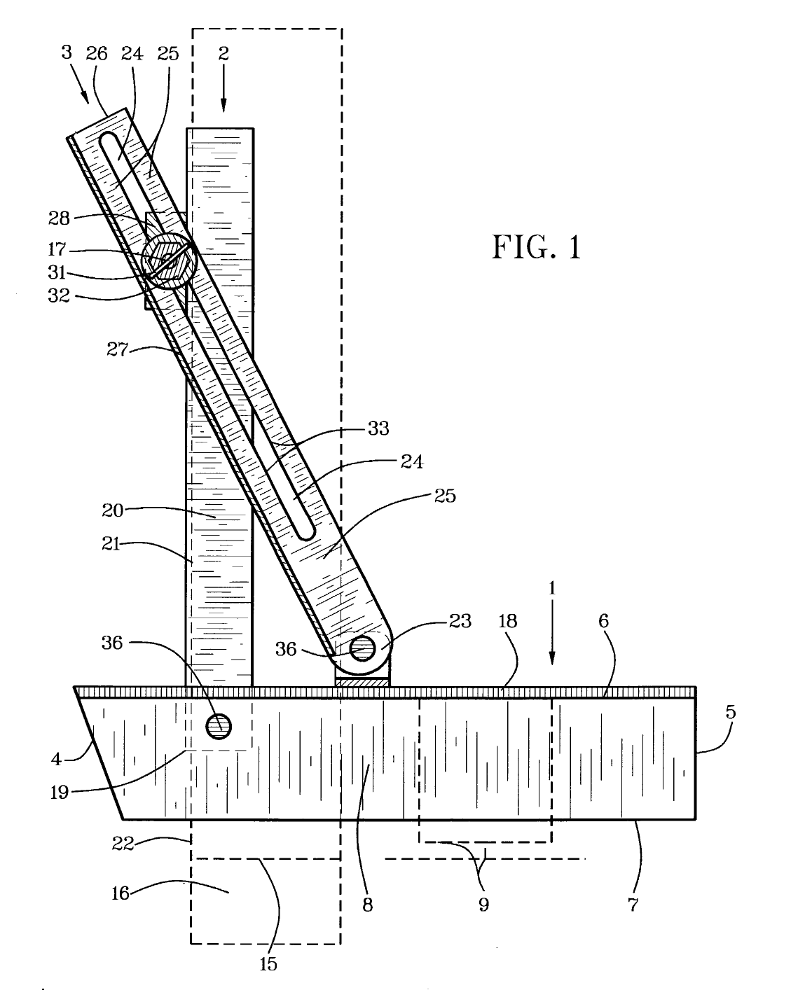

Referring to FIGS. 1-3, a tool-guide beam 1 is hinged to a feedstock-guide beam 2 at an adjustable angle from the tool-guide beam 1 with an angle-adjustment rod 3 intermediate the tool-guide beam 1 and the feedstock-guide beam 2 triangularly.

The tool-guide beam 1 has a feedstock end 4 and an oppositely disposed distal end 5. The tool-guide beam 1 includes a tool-guide side 6 that is oppositely disposed from a tool side 7 of the tool-guide beam 1. The tool-guide beam 1 includes a horizontal tool-support surface 8, also referred to as a table, with a predetermined width, length and structure for supporting a predetermined powered hand tool 9.

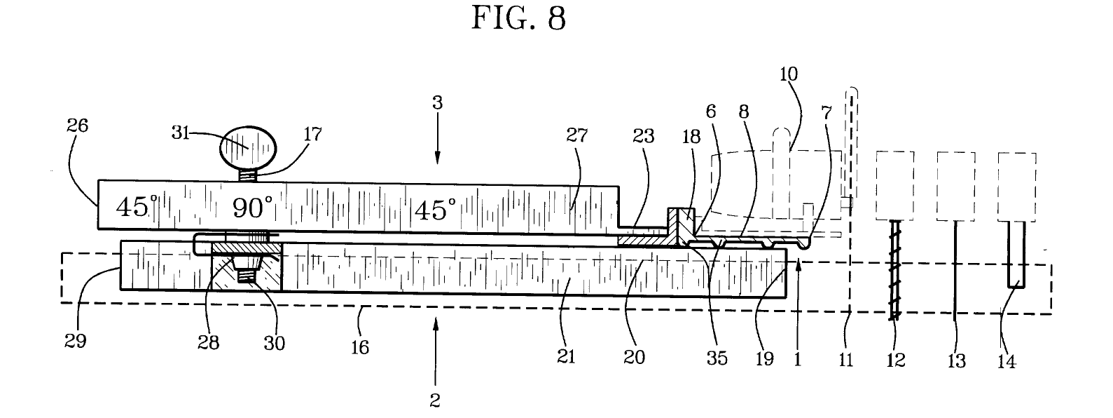

In FIGS. 1-5, the powered hand tool 9 is represented schematically with dashed line in a general outline of a powered circular saw. In FIG. 8, the powered hand tool 9 is depicted in dashed lines as a motorized unit 10 for a selection of powered hand tools represented in dashed lines by power-tool heads that include a circular saw 11, a milling side cutter 12, a blade saw 13 and a router 14 for the motorized unit 10 or for single-purpose, dedicated hand tools. This invention can be used with a wide selection of known powered tools 9-14 for making a cut, groove or finishing activity along a targeted line 15 in a feedstock board 16 that is positioned in the feedstock-guide beam 2 at an angle set by the angle-adjustment rod 3 with an angle-adjustment setscrew 17.

The tool-guide beam 1 has a tool-guide wall 18 extended upward orthogonally from the tool-guide side 6 of the horizontal tool-support surface 8 or table of the tool-guide beam 1.

Referring further to FIGS. 1-5, the feedstock-guide beam 2 has a tool-guide end 19 hinged to an underside of the tool-guide beam 1 at a predetermined distance from the feedstock end 4 of the tool-guide beam 1. The feedstock-guide beam 2 is a right-angled beam having a horizontal wall as a guide support 20 with a predetermined width, length and structure for supporting the woodcutting-angle guide and for supporting weight and operation of the powered hand tool 9-14 with a horizontal bottom surface of the guide support 20 resting on a top surface of a selected feedstock board 16.

The feedstock-guide beam 2 has a surface of a vertical wall of the right-angled beam as a feedstock-guide wall 21 that is extended downward orthogonally from a board-guide side of the horizontal guide-support surface of the guide support 20 of the feedstock-guide beam 2 for sliding-contact guiding of a reference edge 22 of the feedstock board 16.

As shown in FIGS. 1-3 and 7, the angle-adjustment rod 3 has a hinged end 23 that is hinged to the tool-guide side 6 of the tool-guide beam 1 at a predetermined position intermediate the feedstock end 4 and the distal end 5 of the tool-guide beam 1. The angle-adjustment rod 3 includes an angle-adjustment slot 24 in a horizontal groove portion 25 of the angle-adjustment rod 3.

The angle-adjustment slot 24 in the horizontal groove portion 25 of the angle-adjustment rod 3 is collinear to the angle-adjustment rod 3 and extended predeterminedly intermediate the hinged end 23 of the angle-adjustment rod 3 and a rod distal end 26 of the adjustment-angle rod 3 that is oppositely disposed from the hinged end 23. The angle-adjustment rod 3 is a right-angled rod having a rod vertical wall 27 extended uprightly from the horizontal groove portion 25.

A setscrew housing 28 is affixed to the vertical feedstock-guide wall 21 of the feedstock-guide beam 2 at a position predeterminedly proximate a feed end 29 of the feedstock-guide beam 2. The setscrew housing 28 includes a horizontal base with a setscrew aperture having an axis that is perpendicular to the feedstock-guide beam 2 and includes screw thread for receiving mating screw thread 30 of the angle-adjustment setscrew 17. The angle-adjustment setscrew 17 includes a finger-rotatable head 31 proximate a top end, a setscrew-stop member 32 predeterminedly downward from the finger-rotatable head, and the mating screw thread 30 intermediate the setscrew-stop member 32 and a bottom end of the angle-adjustment setscrew 17. The angle-adjustment setscrew 17 is positioned intermediate inside walls 33 of the angle-adjustment slot 24.

The angle-adjustment setscrew 17 is screwed into the machine thread in the setscrew housing 28 for tightness-fixing of groove-portion 25 sides of the angle-adjustment slot 24 against a top surface of the setscrew housing 28. The adjustable angle of the tool-guide beam 1 from the feedstock-guide beam 2 is adjustable to an adjusted angle by the tightness-fixing of the groove-portion 25 sides of the angle-adjustment slot 24 against the top surface of the setscrew housing 28 with the angle-adjustment setscrew 17 being an adjusted-angle distance from the tool-guide beam 1 selectively.

Positioned on the angle-adjustment setscrew 17 in contact with top and bottom surfaces of the groove portion 25 can be various surface-protective washers 34 and resistance washers for protecting the groove portion 25 against sliding and rotating contact by the setscrew-stop member 32 and the setscrew housing 28 and for positional friction.

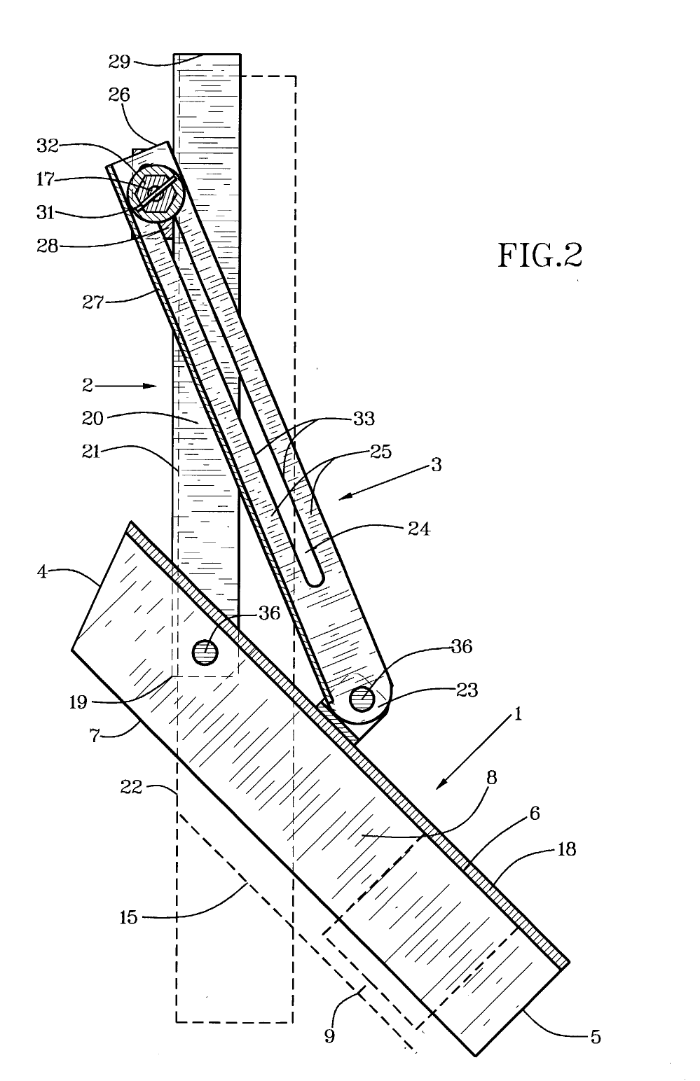

For right-handed users as shown in FIGS. 1-2, the tool-guide side 6 of the tool-guide beam 1 as seen from the feedstock end 4 of the tool-guide beam 1 is a left side of the tool-guide beam 1. The tool-guide wall 18 is extended upward orthogonally from the left side of the horizontal tool-support surface 8 of the tool-guide beam 1 and the hinged end 23 of the angle-adjustment rod 3 is hinged to the left side of the tool-guide beam 1.

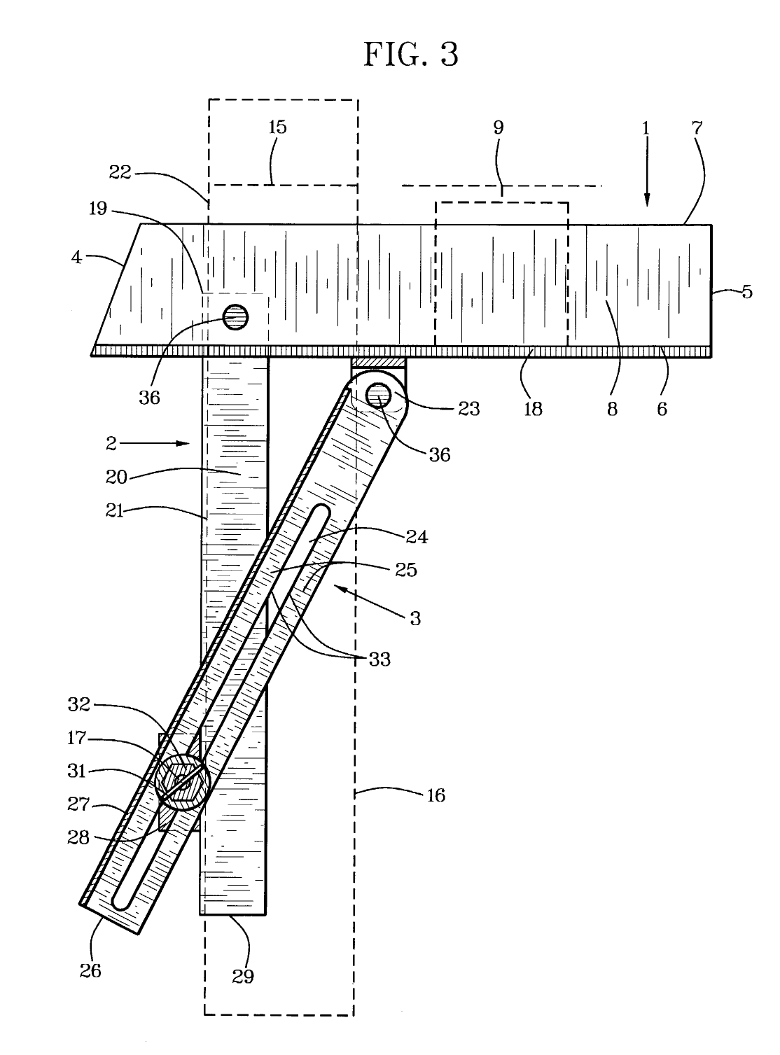

For left-handed users as shown in FIG. 3, the tool-guide side 6 of the tool-guide beam 1 as seen from the feedstock end 4 of the tool-guide beam 1 is a right side of the tool-guide beam 1, the tool-guide wall 18 is extended upward orthogonally from the right side of the horizontal tool-support surface 8 of the tool-guide beam 1 and the hinged end 23 of the angle-adjustment rod 3 is hinged to the right side of the tool-guide beam 1.

This woodcutting-angle guide can be made in any desired size and proportions of its components. Preferably, however, the horizontal top-support surface 8 of the tool-guide beam 1 has a width within a range of two-to-six inches, a length within a range of ten-to-twenty inches and thickness within a range of one-twentieth-to-one quarter of an inch. The tool-guide wall 18 is extended throughout the length of the tool-guide beam 1; it is extended upward from the tool-guide side 6 of the horizontal tool-support surface 8 of the tool-guide beam 1 for a distance within a range of one-quarter-to-one inch; and it has a thickness within a range of one-sixteenth-to-one-quarter of an inch. The feedstock-guide beam 2 has a length within a range of ten-to-twenty inches. The horizontal guide support 20 of the feedstock-guide beam 2 has a width within a range of one-half inch and four inches and a thickness within a range of one-twentieth-and-one-quarter inch. The feed-stock-guide wall 21 of the feedstock-guide beam 2 has a width within a range of one-half inch and four inches and a thickness within a range of one-twentieth-and-one-quarter inch. The angle-adjustment rod 3 has a length within a range of ten-to-twenty inches, a thickness of the horizontal groove portion 25 of the angle-adjustment rod 3 in which the angle-adjustment slot 24 is positioned has a width within a range of one-half-and-one inch and a thickness within a range of one-twentieth-and-one-quarter inch. An uprightly extended rod vertical wall 27 has a height within a range of one-half-and-one inch and a thickness within a range of one-twentieth-and-one-quarter inch.

For inexpensive and light-weight construction, but not necessarily for durable and professional uses, the feedstock-guide beam 2 can include an angle beam of selected structural-aluminum alloy having equally-sized walls that are approximately one-sixteenth of an inch thick and three-quarters of an inch wide. The angle-adjustment rod 3 can include an angle beam of the structural-aluminum alloy having equally-sized walls that are approximately one-sixteenth of an inch thick and three-quarters of an inch wide. The tool-guide beam 1 can include an angle beam of the structural-aluminum alloy having a floor with a thickness of approximately one-sixteenth inch with a plurality of linear stiffeners 35 that are shown in FIG. 8 on a bottom of the horizontal guide-support surface 8. A width of the tool-guide beam 1 for this light and inexpensive construction embodiment can be approximately three-and-one-quarter inches and the tool-guide wall 18 can have a height of approximately one-half inch with a wall thickness of approximately three-thirty-seconds of an inch.

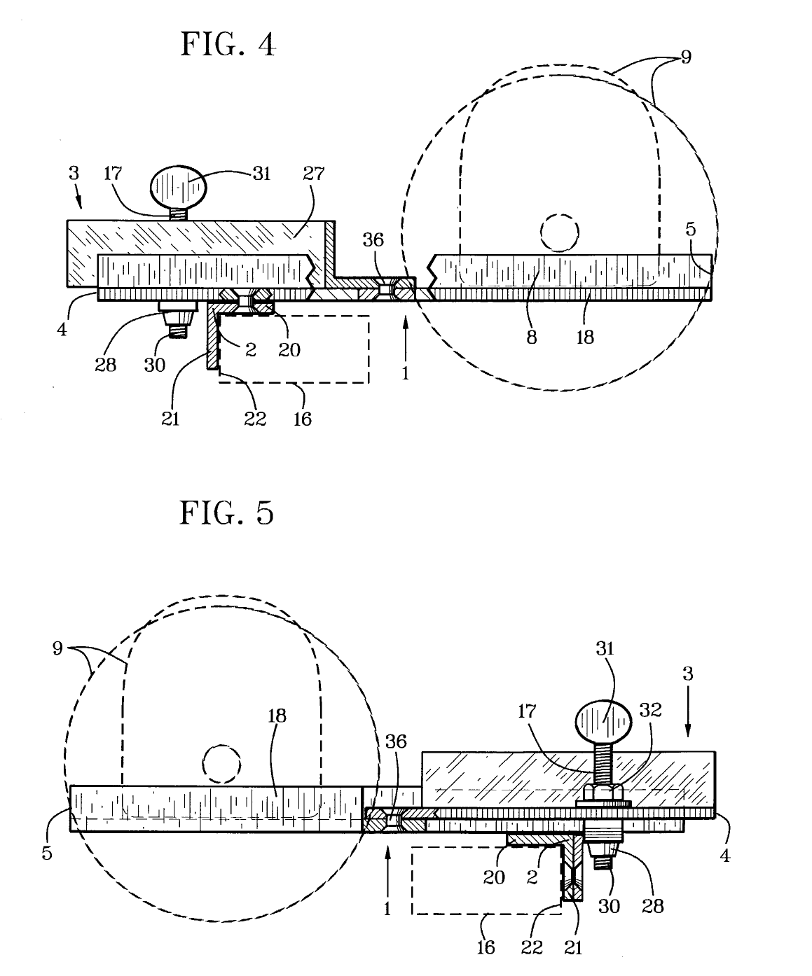

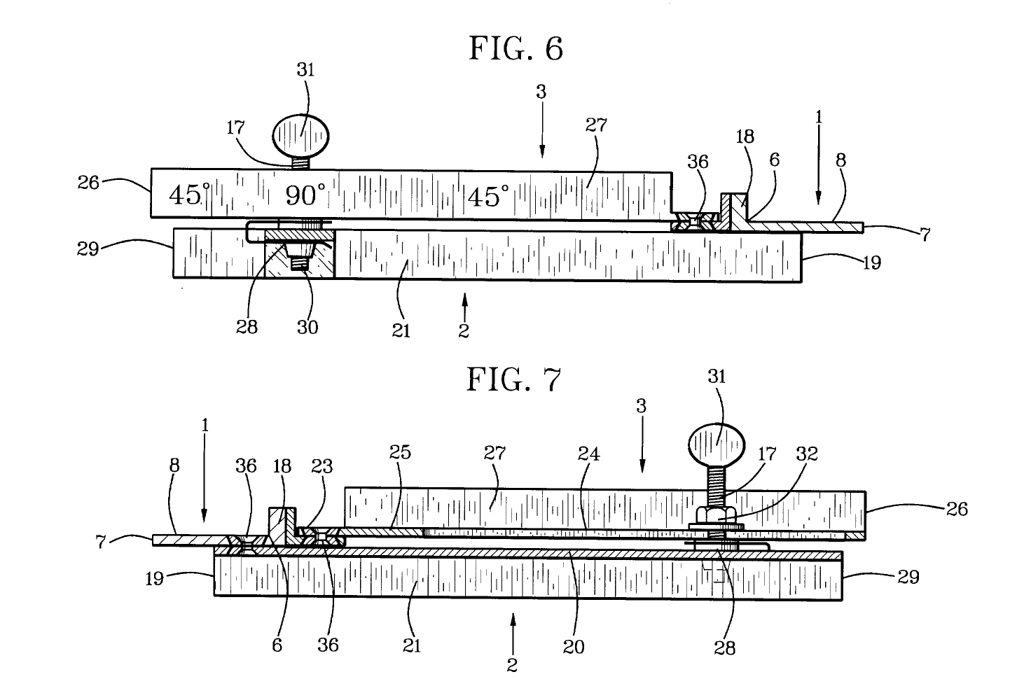

Hinged attachments 36 shown in FIGS. 1-7 are preferably flush with surfaces. Depicted in cutaway portions of FIGS. 4-7 are figurative representations of a selection of known hinged attachments of thin metal sheets that can be employed.

A wide variety of sizes, weights and durability of this woodcutting-angle guide can be produced. Some that are small and thin-walled can be as light as one-half pound. Others that are marketably durable and made with select structural-aluminum-alloy beams approximately 15-to-18 inches long can have a weight one-to-two pounds. Quality of the hinged attachments 36 and components for the angle-adjustment setscrew 17 are critical to accuracy, reliability and durability.

A new and useful woodcutting-angle guide for powered hand tools having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A woodcutting-angle guide comprising:
a tool-guide beam that is hinged to a feedstock-guide beam at an adjustable angle from the tool-guide beam with an angle-adjustment rod intermediate the tool-guide beam and the feedstock-guide beam triangularly;
the feedstock-guide beam being structured for receiving and guiding a feedstock board predeterminedly;
the tool-guide beam being structured for supporting and guiding a powered hand tool predeterminedly;
the angle-adjustment rod having a tool-guide end that is hinged to the tool-guide beam at a predetermined distance intermediate a feedstock end and a distal end of the tool-guide beam;
the feedstock-guide beam having a setscrew housing into which an angle-adjustment setscrew is screwed predeterminedly intermediate a tool-guide end and an oppositely disposed distal end;
the angle-adjustment rod being structured to receive the angle-adjustment setscrew at a select distance from the tool-guide beam; and
the angle-adjustment rod being fixable to the feedstock-guide beam with the angle-adjustment setscrew and the setscrew housing for adjusting the adjustment angle intermediate the tool-guide beam and the feedstock-guide beam selectively.

2. The woodcutting-angle guide of claim 1 wherein:
the tool-guide beam has a feedstock end and an oppositely disposed distal end;
the tool-guide beam has a tool-guide side that is oppositely disposed from a tool side of the tool-guide beam;
the tool-guide beam includes a horizontal tool-support surface with a predetermined width, length and structure for supporting a predetermined powered hand tool; and
the tool-guide beam having a tool-guide wall extended upward orthogonally from the tool-guide side of the horizontal tool-support surface of the tool-guide beam.

3. The woodcutting-angle guide of claim 2 wherein:
the feedstock-guide beam has a tool-guide end hinged to an underside of the tool-guide beam at a predetermined distance from the feedstock end of the tool-guide beam;
the feedstock-guide beam includes a horizontal guide-support surface with a predetermined width, length and structure for supporting the woodcutting-angle guide and for supporting weight and operation of the powered tool with the guide-support surface resting on a top surface of a predetermined feedstock board; and
the feedstock-guide beam having a feedstock-guide wall extended downward at a right angle from the horizontal guide-support surface of the feedstock-guide beam for sliding-contact guiding of a reference edge of the feedstock board.

4. The woodcutting-angle guide of claim 3 wherein:
the angle-adjustment rod has a hinged end that is hinged to the tool-guide side of the tool-guide beam at a predetermined position intermediate the feedstock end and the distal end of the tool-guide beam;
the angle-adjustment rod includes an angle-adjustment slot in a horizontal portion of the angle-adjustment rod; and
the angle-adjustment slot in the horizontal portion of the angle-adjustment rod being collinear to the angle-adjustment rod and extended predeterminedly intermediate the hinged end of the angle-adjustment rod and a distal end of the adjustment-angle rod that is oppositely disposed from the hinged end of the angle-adjustment rod.

5. The woodcutting-angle guide of claim 4 wherein:
the angle-adjustment rod is a right-angled with an upright wall orthogonal to the horizontal portion of the angle-adjustment rod.

6. The woodcutting-angle guide of claim 5 and further comprising:
angle indicia on a the upright wall of the angle-adjustment rod.

7. The woodcutting-angle guide of claim 4 wherein:
the feedstock-guide beam includes a setscrew housing at a position predeterminedly intermediate the hinged end and the distal end of the feedstock-guide beam and on a non-guide side of the feedstock-guide wall that is oppositely disposed from a board-guide side of the feedstock-guide wall;
the setscrew housing having a setscrew aperture with an axis that is perpendicular to the feedstock-guide beam and includes screw thread for receiving mating screw thread of an angle-adjustment setscrew;
the angle-adjustment setscrew includes a finger-rotatable head proximate a top end, a setscrew-stop member predeterminedly downward from the finger-rotatable head, and screw thread intermediate the setscrew-stop member and a bottom end of the angle-adjustment setscrew;
the angle-adjustment setscrew being positioned intermediate inside walls of the angle-adjustment slot in the angle-adjustment rod;
the angle-adjustment setscrew being screwed into the machine thread in the setscrew housing for tightness-fixing of sides of the angle-adjustment slot to a top surface of the setscrew housing; and
the adjustable angle of the tool-guide beam from the feedstock-guide beam is adjustable to an adjusted angle by the tightness-fixing of sides of the angle-adjustment slot to the top surface of the setscrew housing with the angle-adjustment setscrew being an adjusted-angle distance from the tool-guide beam selectively.

8. A woodcutting-angle guide comprising:
a tool-guide beam that is hinged to a feedstock-guide beam at an adjustable angle from the tool-guide beam with an angle-adjustment rod intermediate the tool-guide beam and the feedstock-guide beam triangularly;
the tool-guide beam having a feedstock end and an oppositely disposed distal end;
the tool-guide beam having a tool-guide side that is oppositely disposed from a tool side of the tool-guide beam;
the tool-guide beam including a horizontal tool-support table with a predetermined width, length and structure for supporting a predetermined powered hand tool;
the tool-guide beam having a tool-guide wall extended upward orthogonally from the tool-guide side of the horizontal tool-support table of the tool-guide beam;
the feedstock-guide beam having a tool-guide end hinged to an underside of the tool-guide beam at a predetermined distance from the feedstock end of the tool-guide beam;
the feedstock-guide beam being an right-angled beam;
the right-angled beam having a horizontal wall as a guide support with a predetermined width, length and structure for supporting the woodcutting-angle guide and for supporting weight and operation of the powered tool with a bottom surface of the guide-support resting on a top surface of a predetermined feedstock board;
the feedstock-guide beam having a surface of a vertical wall of the right-angled beam as a feedstock-guide wall extended downward orthogonally from a board-guide side of the horizontal guide-support surface of the guide support of the feedstock-guide beam for sliding-contact guiding of a reference edge of the feedstock board;
the angle-adjustment rod having a hinged end that is hinged to the tool-guide side of the tool-guide beam at a predetermined position intermediate the feedstock end and the distal end of the tool-guide beam;
the angle-adjustment rod including an angle-adjustment slot in a horizontal groove portion of the angle-adjustment rod;
the angle-adjustment slot in the horizontal portion of the angle-adjustment rod being collinear to the angle-adjustment rod and extended predeterminedly intermediate the hinged end of the angle-adjustment rod and a rod distal end of the adjustment-angle rod that is oppositely disposed from the hinged end of the angle-adjustment rod;
the angle-adjustment rod being a right-angled rod having a rod vertical wall extended uprightly from the horizontal groove portion;
a setscrew housing on the vertical wall of the feedstock-guide beam at a position predeterminedly intermediate the hinged end and the distal end of the feedstock-guide beam;
the setscrew housing including a horizontal base with a setscrew aperture having an axis that is perpendicular to the feedstock-guide beam and includes screw thread for receiving mating screw thread of an angle-adjustment setscrew;
the angle-adjustment setscrew including a finger-rotatable head proximate a top end, a setscrew-stop member predeterminedly downward from the finger-rotatable head, and screw thread intermediate the setscrew-stop member and a bottom end of the angle-adjustment setscrew;
the angle-adjustment setscrew being positioned intermediate inside walls of the angle-adjustment slot;
the angle-adjustment setscrew being screwed into the machine thread in the setscrew housing for tightness-fixing of groove-portion sides of the angle-adjustment slot against a top surface of the setscrew housing; and
the adjustable angle of the tool-guide beam from the feedstock-guide beam being adjustable to an adjusted angle by the tightness-fixing of the groove-portion sides of the angle-adjustment slot against the top surface of the setscrew housing with the angle-adjustment setscrew being an adjusted-angle distance from the tool-guide beam selectively.

9. The woodcutting-angle guide of claim 8 wherein:
the tool-guide side of the tool-guide beam as seen from the feedstock end of the tool-guide beam is a left side of the tool-guide beam, the tool-guide wall is extended upward orthogonally from the left side of the horizontal tool-support surface of the tool-guide beam and the hinged end of the angle-adjustment rod is hinged to the left side of the tool-guide beam for right-handed users.

10. The woodcutting-angle guide of claim 8 wherein:
the tool-guide side of the tool-guide beam as seen from the feedstock end of the tool-guide beam is a right side of the tool-guide beam, the tool-guide wall is extended upward orthogonally from the right side of the horizontal tool-support surface of the tool-guide beam and the hinged end of the angle-adjustment rod is hinged to the right side of the tool-guide beam for left-handed users.

11. The woodcutting-angle guide of claim 8 wherein:
the horizontal support surface of the tool-guide beam has a width within a range of two-to-six inches, a length within a range of ten-to-twenty inches and thickness within a range of one-twentieth-to-one quarter of an inch;
the tool-guide wall is extended throughout the length of the tool-guide beam, is extended upward from the tool-guide side of the horizontal tool-support surface of the tool-guide beam for a distance within a range of one-quarter-to-one inch, and has a thickness within a range of one-sixteenth-to-one-quarter of an inch;
the feedstock-guide beam has a length within a range of ten-to-twenty inches, the horizontal guide-support surface of the feedstock-guide beam has a width within a range of one-half inch and four inches and a thickness within a range of one-twentieth-and-one-quarter inch, the feed-stock-guide wall of the feedstock-guide beam has a width within a range of one-half inch and four inches and a thickness within a range of one-twentieth-and-one-quarter inch; and
the angle-adjustment rod has a length within a range of ten-to-twenty inches, a thickness of a horizontal portion of the angle-adjustment rod in which the angle-adjustment slot is positioned has a width within a range of one-half-and-one inch and a thickness within a range of one-twentieth-and-one-quarter inch, and a rod vertical portion has a height within a range of one-half-and-one inch and a thickness within a range of one-twentieth-and-one-quarter inch.

12. The woodcutting-angle guide of claim 8 wherein:
the feedstock-guide beam includes an angle beam of structural-aluminum alloy having equally-sized walls that are approximately one-sixteenth of an inch thick and three-quarters of an inch wide;
the angle-adjustment rod includes an angle beam of structural-aluminum alloy having equally-sized walls that are approximately one-sixteenth of an inch thick and three-quarters of an inch wide;
the tool-guide beam includes an angle beam of structural-aluminum alloy having a floor with a thickness of approximately one-sixteenth inch with a plurality of linear stiffeners oppositely disposed from the horizontal guide-support surface, a width of approximately three-and-one-quarter inches and the tool-guide wall having a height of approximately one-half inch with a wall thickness of approximately three-thirty-seconds of an inch.
